(19) United States
(12) Patent Application Publication
(10) Pub. No.: US 2016/0299971 A1
(43) Pub. Date: Oct. 13, 2016

(54) Identifying Search Engine Crawlers

(71) Applicant: NxLabs Limited, Hong Kong (CN)

(72) Inventors: Rongjin Ren, Guangdong (CN); Wei-Jen Lien, Taipei (TW); Po-Yuan Hsiao, Taipei (TW); Ting-Hsin Chen, Taipei (TW); Ryan Chin, Singapore City (SG)

(21) Appl. No.: 14/684,241

(22) Filed: Apr. 10, 2015

(51) Int. Cl. G06F 17/30; H04L 29/06; H04L 29/08

(52) U.S. Cl. CPC G06F 17/30864; H04L 67/28; H04L 63/0281; H04L 67/02; H04L 63/1416; H04L 63/1441

(57) ABSTRACT

Provided are methods and systems for classifying a search engine crawler. An example system for classifying a search engine crawler can include a proxy, a classifier module, and a blocking module. The proxy can be operable to receive a request from the search engine crawler. The proxy may be further operable to route the request to the classifier module. The classifier module may be operable to classify the search engine crawler. The classification may be performed based on attributes associated with the search engine crawler. Based on the classification, the blocking module may be operable to selectively block the request.

### TECHNICAL FIELD

This disclosure relates generally to data processing and, more specifically, to methods and systems for identifying search engine crawlers.

### BACKGROUND

The approaches described in this section could be pursued but are not necessarily approaches that have been previously conceived or pursued. Therefore, unless otherwise indicated, it should not be assumed that any of the approaches described in this section qualify as prior art merely by virtue of their inclusion in this section.

Cybercriminals continually find new techniques for attacking enterprise networks and popular websites. In one such technique, attackers can launch Distributed Denial of Service (DDoS) attacks against websites using web crawlers. Web crawlers, also known as search engine crawlers or Internet bots, can systematically browse the Internet for the purpose of indexing websites. The web crawlers are typically used by web search engines, also referred to as search engines, to collect or update indexes of web content. A web crawler can visit webpages of websites and copy the webpages for later processing by a search engine. The search engine may index the downloaded webpages, thereby providing users with quick search results.

The attackers can take advantage of the fact that web crawlers are allowed to access content of the website by creating forged search engine crawlers. The forged search engine crawlers may pretend to be web crawlers associated with well-known search engines. Conventional methods for identification and blocking of malicious web crawlers include separating the forged and legitimate web crawlers based on the point of origin of the web crawlers. The point of origin can be determined based on a user-agent string contained in requests sent by web crawlers. The user-agent string of the web crawlers may be inspected for various parameters such as, for example, a Uniform Resource Locator and an e-mail address. However, attackers may spoof a user-agent string to misrepresent a forged web crawler as a legitimate web crawler.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The present disclosure is related to approaches for identifying search engine crawlers. Specifically, according to one example embodiment, a system for classifying a search engine crawler is provided. The system can include a proxy, a classifier module, and a blocking module. The proxy can be operable to receive a request from the search engine crawler. The proxy may be further operable to route the request to the classifier module. The classifier module may be operable to classify the search engine crawler. The classifying may be performed based on attributes associated with the search engine crawler. Based on the classifying performed by the classifier module, the blocking module may be operable to selectively block the request.

According to another example embodiment of the disclosure, a method for classifying a search engine crawler is provided. The method can include receiving a request from the search engine crawler. The request may be received by a proxy. The method may further include routing, by the proxy, the request to a classifier module. Upon receiving the request by the classifier module, the classifier module may classify the search engine crawler based on attributes associated with the search engine crawler. The method may further include selectively blocking access of the search engine crawler based on the classification. The blocking may be performed by a blocking module.

Other example embodiments of the disclosure and aspects will become apparent from the following description taken in conjunction with the following drawings.

### BRIEF DESCRIPTION OF THE DRAWINGS

Embodiments are illustrated by way of example and not limitation in the figures of the accompanying drawings, in which like references indicate similar elements.

FIG. 1 illustrates an environment within which methods for classifying a search engine crawler can be practiced.

FIG. 2 is a process flow diagram showing a method for classifying a search engine crawler.

FIG. 3 is a block diagram of a system for classifying a search engine crawler.

FIG. 4 illustrates a process flow diagram of a method for classifying a search engine crawler.

FIG. 5 illustrates an example computer system that may be used to implement embodiments of the present disclosure.

### DETAILED DESCRIPTION

The following detailed description includes references to the accompanying drawings, which form a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, other embodiments can be utilized, or structural, logical and electrical changes can be made without departing from the scope of what is claimed. The following detailed description is, therefore, not to be taken in a limiting sense, and the scope is defined by the appended claims and their equivalents. In this document, the terms “a” and “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

Methods and systems for classifying a search engine crawler are provided. A system for classifying a search engine crawler can identify whether the search engine crawler is a legitimate search engine crawler or a forged search engine crawler. The system can perform a several step verification to identify forged search engine crawlers. More specifically, the system can include a proxy that handles incoming network traffic and forwards the processed network traffic to a classifier module. The classifier module may analyze, parse, and interpret network packets associated with the search engine crawlers. The interpreted data associated with network packets may be used to analyze behavior of the search engine crawlers. The network packets may include network packets of requests sent by search engine crawlers to a website or a server.

The verification performed by the classifier module may include checking whether the search engine crawler is registered in a database. Requests from non-registered search engine crawlers may be dropped without any further analysis. The next step of verification may include determining whether the search engine crawler is associated with a well-known search engine. For this purpose, information associated with the search engine crawler may be analyzed to determine the name of the search engine. Requests from the search engine crawlers associated with the search engines having names that are not well-known may be dropped. Additionally, the classifier module may check whether a domain name calculated from the request is associated with a well-known search engine. If the domain name is associated with the well-known search engine, the search engine crawler may be registered in the database and the request of the search engine crawler may be sent to the server. The classifier module may further analyze the frequency of requests sent by a search engine crawler to the server. Requests from search engine crawlers that send requests frequently may be dropped.

Based on the results provided by the classifier module, legitimate requests may be allowed to pass through and suspicious requests blocked. Thus, the system can classify search engine crawlers and prevent forged search engine crawlers from overloading the server by sending multiple requests. The architecture of the system enables handling large amounts of data even in the DDoS attack period.

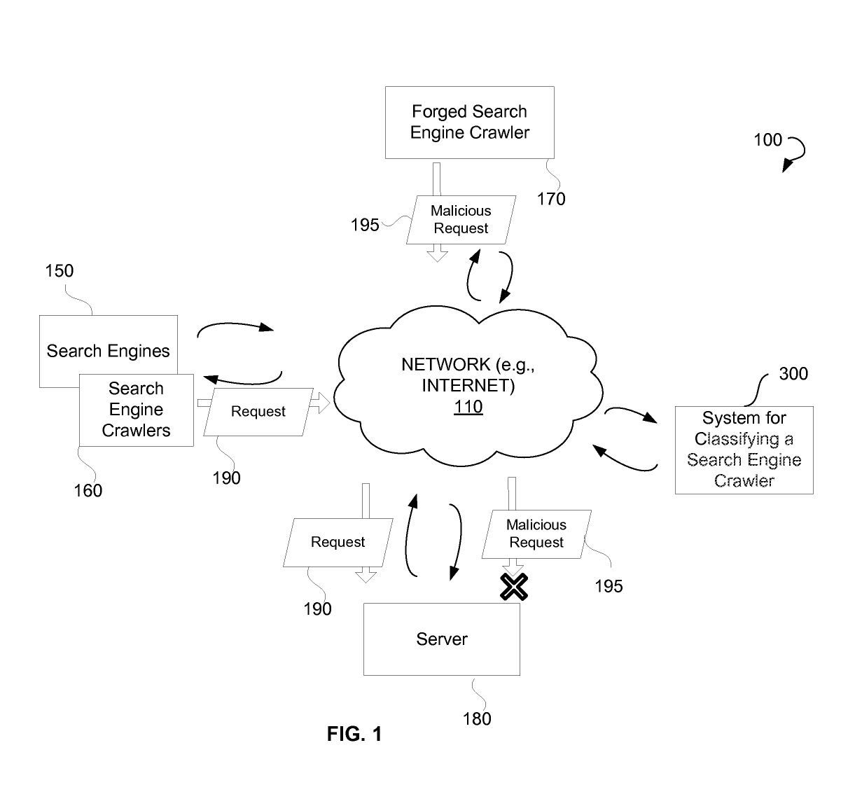

Referring now to the drawings, FIG. 1 shows an environment 100 within which methods and systems for classifying a search engine crawler can be practiced. The environment 100 may include a network 110, a system 300 for classifying a search engine crawler, a plurality of search engines 150, a plurality of search engine crawlers 160 each being associated with one of the search engines 150, a forged search engine crawler 170, and a server 180.

The network 110 may include the Internet or any other network capable of communicating data between devices. Suitable networks may include or interface with any one or more of, for instance, a local intranet, a Personal Area Network, a Local Area Network, a Wide Area Network, a Metropolitan Area Network, a virtual private network, a storage area network, a frame relay connection, an Advanced Intelligent Network connection, a synchronous optical network connection, a digital T1, T3, E1 or E3 line, Digital Data Service connection, Digital Subscriber Line connection, an Ethernet connection, an Integrated Services Digital Network line, a dial-up port such as a V.90, V.34 or V.34bis analog modem connection, a cable modem, an ATM (Asynchronous Transfer Mode) connection, or a Fiber Distributed Data Interface or Copper Distributed Data Interface connection. Furthermore, communications may also include links to any of a variety of wireless networks, including Wireless Application Protocol, General Packet Radio Service, Global System for Mobile Communication, Code Division Multiple Access or Time Division Multiple Access, cellular phone networks, Global Positioning System, cellular digital packet data, Research in Motion, Limited duplex paging network, Bluetooth radio, or an IEEE 802.11-based radio frequency network. The network 110 can further include or interface with any one or more of an RS-232 serial connection, an IEEE-1394 (FireWire) connection, a Fiber Channel connection, an IrDA (infrared) port, a Small Computer Systems Interface connection, a Universal Serial Bus (USB) connection or other wired or wireless, digital or analog interface or connection, mesh or Digi® networking. The network 110 may include a network of data processing nodes that are interconnected for the purpose of data communication.

The server 180 may be accessed by the plurality of search engine crawlers 160. More specifically, the search engines 150 may index content related to the server 180 to facilitate fast and accurate information retrieval with respect to the server 180. Indexing can be facilitated by the search engine crawlers 160. To access the content of the server 180, the search engine crawlers 160 may send requests 190 to the server 180.

The forged search engine crawler 170 may attempt to imitate a legitimate search engine crawler, such as one of the search engine crawlers 160 associated with the search engines 150. The forged search engine crawler 170 may send malicious requests 195 to the server 180. The system 300 may analyze all requests coming to the server and identify legitimate search engine crawlers and forged search engine crawlers. Based on the analysis, the system 300 may pass the requests 190 from the search engine crawlers 160 to the server 180 and block the malicious requests 195 from the forged search engine crawler 170.

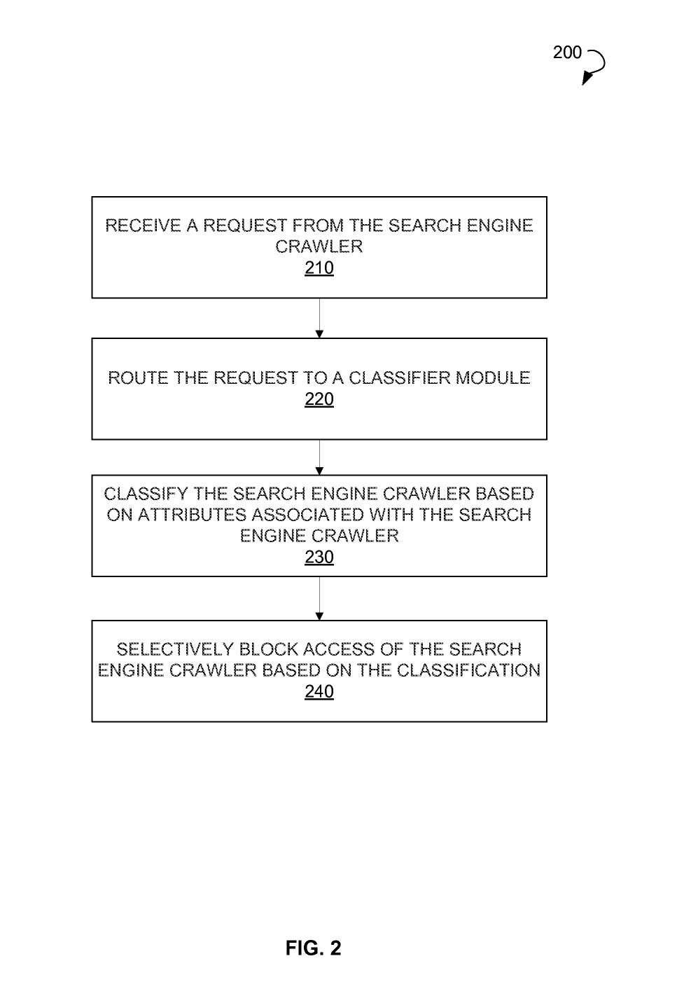

FIG. 2 is a process flow diagram showing a method 200 for classifying a search engine crawler, according to an example embodiment. The method 200 may commence with receiving a request from the search engine crawler at operation 210. The request may be received by a proxy. Upon receiving the request, the proxy may route the request to a classifier module at operation 220.

At operation 230, the classifier module may classify the search engine crawler based on attributes associated with the search engine crawler. In example embodiments, the attributes include an Internet Protocol (IP) address, a Hypertext Transfer Protocol (HTTP) header, a Hypertext Transfer Protocol Secure (HTTPS) header, and the like.

In an example embodiment, the classification includes determining whether the attributes associated with the search engine crawler are stored in a database. The database may store attributes associated with a plurality of search engine crawlers. In an example embodiment, the IP address associated with the request may be searched for in the database.

Additionally, the classifier module may determine whether a name of the search engine associated with the search engine crawler is well-known. In an example embodiment, because the names of well-known search engines and IP addresses of the well-known search engines are public, the determination that the name of the search engine is well-known can be based on the IP address associated with the request. Optionally, the classifier module may further calculate a name of the search engine crawler associated with the request. In an example embodiment, the calculation of the name of the search engine crawler is based on a User-Agent parameter in the HTTP header or the HTTPS header depending on the type of the request.

The classifier module may further determine whether a domain associated with the request is well known. For example, if the search engine crawler is associated with a known official organization, then it can be determined that the search engine crawler is legitimate. If the domain is well known, the method 200 may further include registering the searching engine crawler with the database.

The classifying may further include determining the frequency of access by the search engine crawler, i.e., frequency of requests sent by the search engine crawler, is above a predetermined threshold value. Additionally, the classifier module may determine a score indicative of validity of the request from the search engine crawler. The score may include a sum of weighted values. In an example embodiment, the weighed values include at least one of the following: an Autonomous System Number (ASN), an Internet Protocol (IP) registration, a Pointer (PTR) record, and an access frequency.

In an example embodiment, the score may be calculated based on a formula:

Score=Weight-A×IP ASN+Weight-B×IP registration++Weight-C×PTR record [IP]+Weight-D×[Access Frequency],

where Weight-A, Weight-B, Weight-C, and Weight-D are weighted values. The score indicative of validity of the request can be compared with a predetermined score value.

In an example embodiment, the classification of the search engine crawler may be further based on preferences provided by a customer. Based on the classification, access of the search engine crawler may be selectively blocked by a blocking module at operation 240. The blocking of the access of the search engine crawler may be based on at least one of the following: the name of the search engine is not well-known, the domain associated with the request is not well-known, the frequency of access by the search engine crawler is above the predetermined threshold value, and the score indicative of validity of the request is below a predetermined score value.

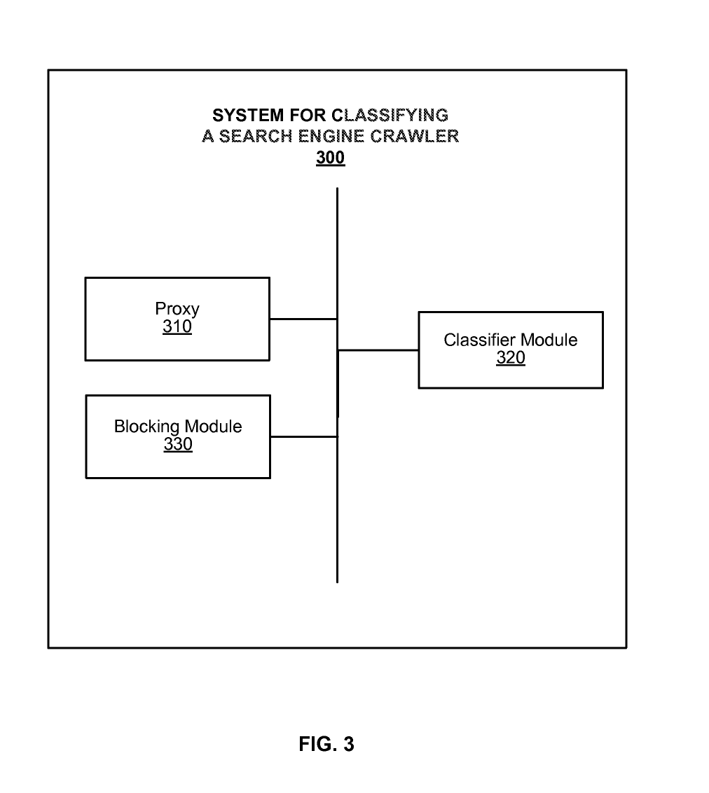

FIG. 3 is a block diagram of a system 300 for classifying a search engine crawler, according to an example embodiment. The system 300 may include a proxy 310, a classifier module 320, and a blocking module 330. The proxy 310 may be configured to receive a request from the search engine crawler. Furthermore, the proxy 310 may be configured to route the request to the classifier module 320. In an example embodiment, the proxy 310 can include a forward proxy or a reverse proxy.

The forward proxy may include an intermediate server located between a user and a server. In order to get content from the server, the user may send a request to the forward proxy and name the server as the target, and the forward proxy may then request the content from the server and return the content to the user. The forward proxy may be used to provide Internet access to users behind a firewall.

The reverse proxy may appear to a client as an ordinary web server. The client may make ordinary requests for content directed to the reverse proxy. The reverse proxy may decide how to forward the requests and return content appearing to the client as if the reverse proxy was providing the content itself. The reverse proxy may be used to provide the users with Internet access to a server that is behind a firewall.

The classifier module 320 may be operable to classify the search engine crawler based on attributes associated with the search engine crawler. In example embodiments, the attributes include an IP address, an HTTP header, an HTTPS header, and the like. In an example embodiment, the classifying includes determining whether the attributes associated with the search engine crawler are stored in a database. The database may store attributes associated with search engine crawlers.

Additionally, the classifier module may determine whether a name of the search engine associated with the search engine crawler is well-known. In an example embodiment, the determination that the name of the search engine is well-known is based on the IP address associated with the request.

The classifier module may further determine whether a domain associated with the request is well-known. In an example embodiment, the determination that the domain associated with the request is well-known is based on a User-Agent parameter in the HTTP or HTTPS header of the request. If the domain is well-known, the classifier module may be further configured to register the searching engine crawler with the database.

The classification may further include determining that a frequency of access by the search engine crawler is above a predetermined threshold value. Additionally, the classifier module may determine a score indicative of validity of the request from the search engine crawler. The classifying of the search engine crawler may further be based on preferences provided by a customer.

The blocking module 330 may be operable to selectively block the request based on the classification performed by the classifier module 320. The blocking of the access of the search engine crawler may be based on at least one of the following: the name of the search engine is not well-known, the domain associated with the request is not well-known, the frequency of access by the search engine crawler is above the predetermined threshold value, and the score indicative of validity of the request is below a predetermined score value. The score may include a sum of weighted values. In an example embodiment, the weighed values include at least one of the following: an ASN, an IP registration, a PTR record, and an access frequency.

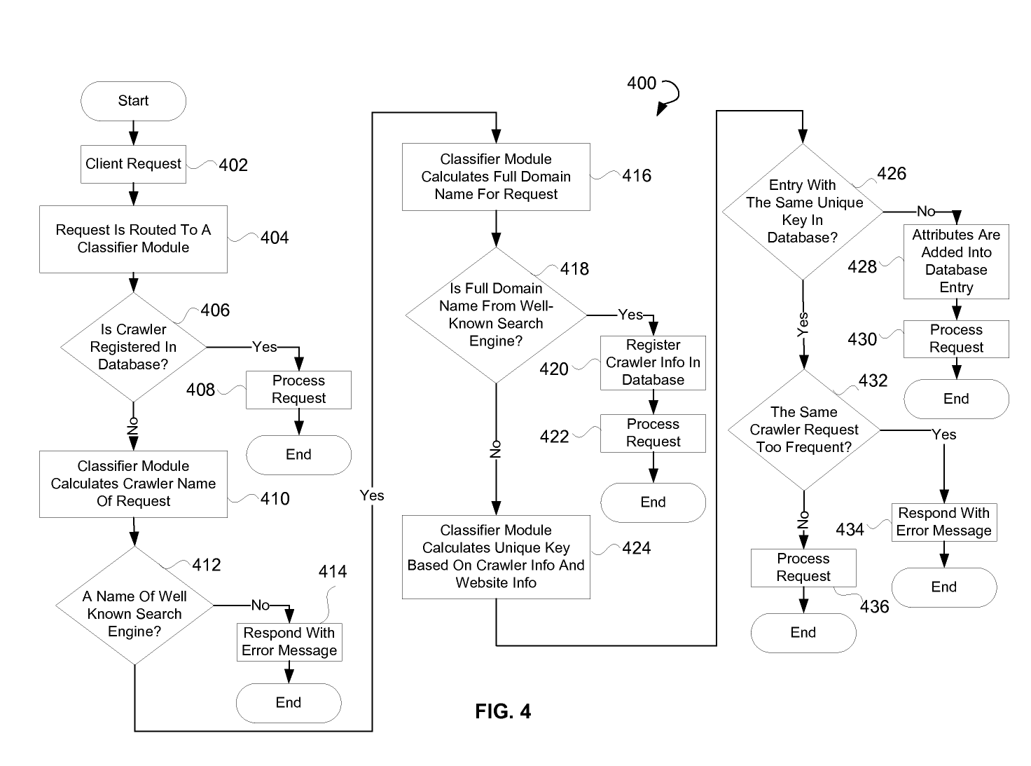

FIG. 4 is a flow chart of a detailed method 400 for classifying a search engine crawler, according to an example embodiment. The method 400 may start with receiving a client request at operation 402. The client request may be routed to a classifier module at operation 404. At decision block 406, the classifier module may determine whether the search engine crawler is registered in a database. The database may store information associated with well-known search engine crawlers or search engine crawlers which have previously accessed the website. In case the search engine crawler is registered in the database, the client request may be processed at operation 408. Processing of the client request may include identifying the client request as legitimate and providing the search engine crawler with access to a website.

If the search engine crawler is not registered in the database, the classifier module can calculate a name of the search engine crawler at operation 410. More specifically, at decision block 412, the classifier module may determine, based on the name of the search engine crawler, whether the name of the search engine associated with the search engine crawler is well-known. If the name of the search engine determined by the classifier module is not the name of a well-known search engine, the client request may be responded to with an error message at operation 414. Accordingly, access to the website for the search engine crawler can be blocked. In an example embodiment, based on determination that the client request is forged, a message with an HTTP 403 Forbidden error may be returned in response to the request from the search engine crawler, thereby indicating that the server refuses to take any further action with respect to the request. In some embodiments, information associated with the dropped requests may be logged for further analysis.

If the name established by the classifier module is the name of a well-known search engine, the classifier module may proceed to calculate a full domain name associated with the search engine crawler at operation 416. More specifically, at decision block 418, the classifier module can determine whether the full domain name is associated with a well-known search engine. If the full domain name is associated with a well-known search engine, the classifier module may register the information associated with the search engine crawler in the database at operation 420. Upon registering the information associated with the search engine crawler in the database, the client request may be processed at operation 422.

If the full domain name calculated by the classifier module is not associated with the well-known search engine, the classifier module may calculate, at operation 424, a unique key based on information associated with the search engine crawler, such as the name of the search engine crawler, and information related to the website. In an example embodiment, the information related to the website may include an identification number issued for the website. More specifically, at decision block 426, the classifier module may determine whether the same unique key is already stored in the database. If the unique key is not already stored in the database, attributes associated with the search engine crawler can be stored in the database at operation 428. The attributes may include an IP address, an HTTP header, an HTTPS header, and other characteristics. After storing the attributes in the database, the client request may be processed at operation 430.

If the unique key is already present in the database, the classifier module may determine the frequency of sending the same request by the search engine crawler at decision block 432. If the frequency is above a predetermined threshold value, i.e., the client request is sent too frequently, the client request may be responded to with an error message at operation 434. If the frequency is below the predetermined threshold value, the client request may be processed at operation 436.

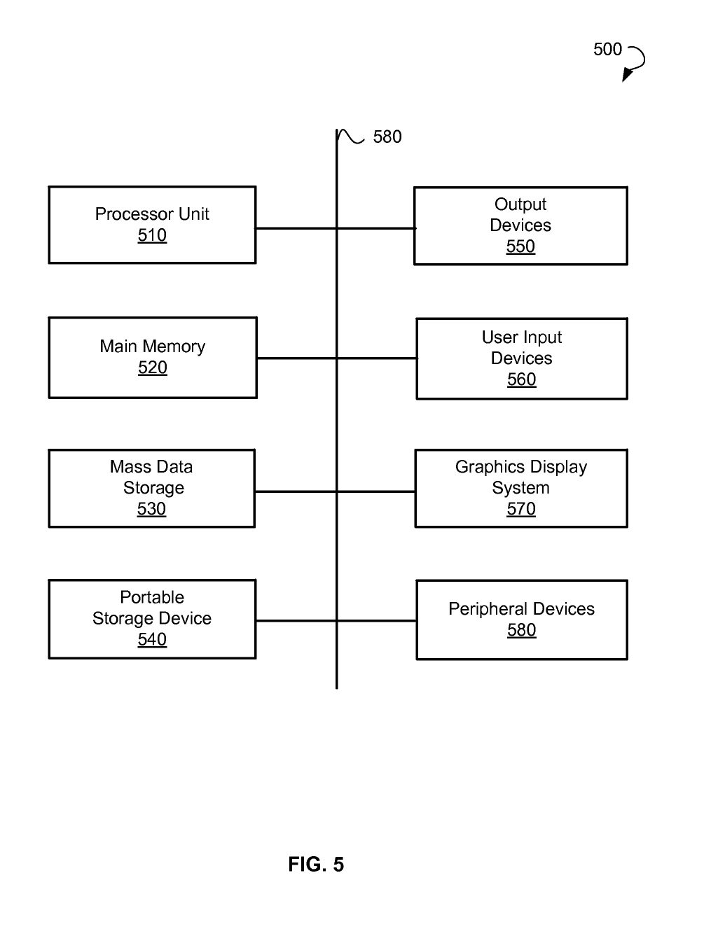

FIG. 5 illustrates an exemplary computer system 500 that may be used to implement some embodiments of the present disclosure. The computer system 500 may be implemented in the contexts of the likes of computing systems, networks, servers, or combinations thereof. The computer system 500 may include one or more processor units 510 and main memory 520. Main memory 520 stores, in part, instructions and data for execution by processor units 510. In this example, main memory 520 stores the executable code when in operation. The computer system 500 further includes a mass data storage 530, portable storage device 540, output devices 550, user input devices 560, a graphics display system 570, and peripheral device(s) 580.

The components shown in FIG. 5 are depicted as being connected via a single bus 580. The components may be connected through one or more data transport means. Processor unit 510 and main memory 520 are connected via a local microprocessor bus, and the mass data storage 530, peripheral device(s) 580, portable storage device 540, and graphics display system 570 are connected via one or more input/output (I/O) buses.

Mass data storage 530, which can be implemented with a magnetic disk drive, solid state drive, or optical disk drive, is a non-volatile storage device for storing data and instructions for use by processor unit 510. Mass data storage 530 stores the system software for implementing embodiments of the present disclosure for purposes of loading that software into main memory 520.

Portable storage device 540 operates in conjunction with a portable non-volatile storage medium, such as a flash drive, floppy disk, compact disk, digital video disc, or USB storage device, to input and output data and code to and from the computer system 500. The system software for implementing embodiments of the present disclosure is stored on such a portable medium and input to the computer system 500 via the portable storage device 540.

User input devices 560 can provide a portion of a User Interface. User input devices 560 may include one or more microphones, an alphanumeric keypad, such as a keyboard, for inputting alphanumeric and other information, or a pointing device, such as a mouse, a trackball, stylus, or cursor direction keys. User input devices 560 can also include a touchscreen. Additionally, the computer system 500 includes output devices 550. Suitable output devices 550 include speakers, printers, network interfaces, and monitors.

Graphics display system 570 includes a liquid crystal display or other suitable display device. Graphics display system 570 is configurable to receive textual and graphical information and process the information for output to the display device.

Peripheral devices 580 may include any type of computer support device to add additional functionality to the computer system.

The components provided in the computer system 500 are those typically found in computer systems that may be suitable for use with embodiments of the present disclosure and are intended to represent a broad category of such computer components that are well-known in the art. Thus, the computer system 500 can be a personal computer, handheld computer system, telephone, mobile computer system, workstation, tablet, phablet, mobile phone, server, minicomputer, mainframe computer, wearable, or any other computer system. The computer may also include different bus configurations, networked platforms, multi-processor platforms, and the like. Various operating systems may be used including UNIX, LINUX, WINDOWS, MAC OS, PALM OS, QNX ANDROID, IOS, CHROME, TIZEN, and other suitable operating systems.

The processing for various embodiments may be implemented in software that is cloud-based. In some embodiments, the computer system 500 is implemented as a cloud-based computing environment, such as a virtual machine operating within a computing cloud. In other embodiments, the computer system 500 may itself include a cloud-based computing environment, where the functionalities of the computer system 500 are executed in a distributed fashion. Thus, the computer system 500, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners, or such systems may be accessible to outside users who deploy applications within the computing infrastructure to obtain the benefit of large computational or storage resources.

The cloud may be formed, for example, by a network of web servers that comprise a plurality of computing devices, such as the computer system 500, with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depends on the type of business associated with the user.

Thus, methods and systems for classifying a search engine crawler have been described. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A system for classifying a search engine crawler, the system comprising:
a proxy operable to:
receive a request from the search engine crawler; and
route the request to a classifier module;
the classifier module operable to classify the search engine crawler based on attributes associated with the search engine crawler; and
a blocking module operable to selectively block the request based on the classification.

2. The system of claim 1, wherein the proxy includes one of the following: a forward proxy and a reverse proxy.

3. The system of claim 1, wherein the classifier module is further configured to register the searching engine crawler with a database.

4. The system of claim 1, wherein the classifying includes at least one of the following:
determining, by the classifier module, whether the attributes associated with the search engine crawler are stored in a database;
determining, by the classifier module, whether a name of the search engine is well known;
determining, by the classifier module, whether a domain associated with the request is well known;
determining, by the classifier module, whether a frequency of access by the search engine crawler is above a predetermined threshold value; and
determining, by the classifier module, a score indicative of validity of the request from the search engine crawler.

5. The system of claim 4, wherein the determination that the name of the search engine is well-known is based on an Internet Protocol (IP) address and the determination that the domain associated with the request is well-known is based on a User-Agent parameter in a Hypertext Transfer Protocol (HTTP) header or a Hypertext Transfer Protocol Secure (HTTPS) header.

6. The system of claim 4, wherein the classifying the search engine crawler is further based on settings provided by a customer.

7. The system of claim 1, wherein the blocking the access of the search engine crawler is based on at least one of the following: the name of the search engine is not well-known, the domain associated with the request is not well-known, the frequency of access by the search engine crawler is above the predetermined threshold value, and the score indicative of validity of the request is below a predetermined score value.

8. The system of claim 7, wherein the score includes a sum of weighted values.

9. The system of claim 8, wherein the weighted values include at least one of the following: an Autonomous System Number (ASN), an IP registration, a Pointer (PTR) record, and an access frequency.

10. The system of claim 1, wherein the attributes include at least an IP address and an HTTP header or an HTTPS header.

11. A computer-implemented method for classifying a search engine crawler, the method comprising:
receiving, by a proxy, a request from the search engine crawler;
routing, by the proxy, the request to a classifier module;
classifying, by the classifier module, the search engine crawler based on attributes associated with the search engine crawler; and
selectively block, by a blocking module, access of the search engine crawler based on the classifying.

12. The method of claim 11, further comprising registering, by the classifier, the searching engine crawler with a database.

13. The method of claim 11, wherein the classifying includes at least one of the following:
determining, by the classifier module, whether the attributes associated with the search engine crawler are stored in a database;
determining, by the classifier module, whether a name of the search engine is well-known;
determining, by the classifier module, whether a domain associated with the request is well-known;
determining, by the classifier module, whether a frequency of access by the search engine crawler is above a predetermined threshold value; and
determining, by the classifier module, a score indicative of validity of the request from the search engine crawler.

14. The method of claim 13, wherein the determination that the name of the search engine is well-known is based on the IP address and the determination that the domain associated with the request is well-known is based on a User-Agent parameter in an HTTP header or an HTTPS header.

15. The method of claim 13, wherein the classifying of the search engine crawler is further based on preferences provided by a customer.

16. The method of claim 11, wherein the blocking the access of the search engine crawler is based on at least one of the following: the name of the search engine is not well-known, the domain associated with the request is not well-known, the frequency of access by the search engine crawler is above the predetermined threshold value, and the score indicative of validity of the request is below a predetermined score value.

17. The method of claim 16, wherein the score includes a sum of weighted values.

18. The method of claim 17, wherein the weighted values include at least one of the following: an ASN, an IP registration, a PTR record, and an access frequency.

19. The method of claim 11, wherein the attributes include an IP address and an HTTP header or an HTTPS header.

20. A system for classifying a search engine crawler, the system comprising:
a proxy operable to:
receive a request from the search engine crawler; and
route the request to a classifier module, wherein the proxy includes one of the following:
a forward proxy and a reverse proxy;
the classifier module operable to:
classify the search engine crawler based on attributes associated with the search engine crawler, wherein the classifying includes determining that a frequency of access by the search engine crawler is above a predetermined threshold value, wherein the classifying of the search engine crawler is further based on preferences provided by a customer;
register the searching engine crawler with a database; and
a blocking module operable to selectively block the request based on the analysis by the classifier module.
